(19) United States
(12) Patent Application Publication
(10) Pub. No.: US 2011/0026775 A1
(43) Pub. Date: Feb. 3, 2011

(54) METHOD FOR MEASUREMENT OF A FLOW IN AN OBJECT, ESPECIALLY A LUMEN OR A VESSEL

(75) Inventors: Irina Waechter, Aachen (DE); Jorg Bredno, San Francisco, CA (US); Jurgen Weese, Aachen (DE); David John Hawker, Crawley (GB); Kawaldeep Singh Rhode, Croydon (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/673,988

(22) PCT Filed: Aug. 18, 2008
(86) PCT No.: PCT/IB08/53307

§ 371 Date: Feb. 18, 2010

(30) Foreign Application Priority Data
Aug. 20, 2007 (EP) 07114586.6

(51) Int. Cl. G06T 7/20

(52) U.S. Cl. 382/107; 382/130

(57) ABSTRACT

It is disclosed a method and a device for measurement of a flow in an object, especially a lumen or a vessel, comprising: generating a temporal sequence of images of the object; determining reliability maps, whereas a reliability map corresponds to an image of the object. Another exemplary embodiment is a method and a device for calculating flow parameters (13), comprising: comparing (15) of a predicted image of a flow (16) with an image of a flow (17) with respect to a reliability map (18) of an image of the flow; and adaptation (12) of the predicted flow (16) with respect to the result of the comparing (15). Furthermore, it is described a computer program having instructions recorded thereon in order to execute one of the above-mentioned methods.

### FIELD OF INVENTION

The present invention relates to the field of measuring the flow in an object, especially a lumen or a vessel.

### BACKGROUND OF THE INVENTION

The document US 2003/0040669 A1 relates to a method of imaging a vascular tree that yields additional information concerning the vascular tree. There is also disclosed an X-ray device to carry out this method.

Many applications, among them some medical (diagnosis, treatment planning and outcome control of neurovascular or coronary disease) require to measure flow. When direct measurements are not possible, imaging of the advance of a contrast agent can be applied. From the images, the amount of this contrast agent can be observed at fixed positions in the lumen/vessel over time (Time-intensity curve TIC) or along the streamlines of the flow at fixed points in time (Distance-intensity curve DIC). Such curves are input to analysis methods that determine flow from images. Also, the sum of all contrast agent contained in an image or region thereof can be used.

As an extension, the amount of contrast agent can be observed at all possible positions and points in time. This combination of TIC and DIC is called flow map.

Often, the amount of contrast agent at a certain position and time is determined by comparison to an image of the object without contrast image, the so-called mask image.

### SUMMARY OF THE INVENTION

It is an object of the present invention to improve the measurement of a flow in an object, especially a lumen or a vessel. This object is achieved by the teachings of the independent claims. Preferred embodiments are described in the dependent claims.

According to an exemplary embodiment a method for measurement of a flow in an object, especially a lumen or a vessel, comprises: generating a temporal sequence of images of the object; determining reliability maps, whereas a reliability map corresponds to an image of the object; determining the flow based on the temporal sequence of images of the object and the reliability maps.

The advantage thereof is the possibility to evaluate the temporal sequence of images according to different criteria. E.g. the area of overlapping vessels, the movement of the object, e.g. because of heartbeat, or the movement of the device to take the images can lead to a lower quality of the image. These aspects will be considered with the help of reliability maps. Therefore, a reliability map provide information about the reliability of single aspects of an image. The result thereof is to avoid misinterpretation of an image.

According to another exemplary embodiment the reliability map depends on a geometry of the object.

According to another exemplary embodiment the geometry is derived on basis of the images of the object.

According to an exemplary embodiment the reliability map depends on a device, which generates the sequence of images.

According to another exemplary embodiment the method further comprises: injecting a contrast agent into the object, especially the vessel; determining the flow at least partially based on a temporal sequence of images of the contrast agent.

According to an exemplary embodiment the images are differently oriented.

According to another exemplary embodiment the reliability map depends on the relationship between the direction of the flow and the direction of the image.

An exemplary aspect of an exemplary embodiment of the invention may be seen in that, the reliability map depends on overlapping lumens, especially on overlapping vessels.

According to an exemplary embodiment the reliability map depends on the quality of the image, especially on edges in a mask image or on artefacts that e.g. can appear when the amount of contrast agent is determined by comparison to mask images.

According to another exemplary embodiment the reliability map is displayed for evaluation of the method for measurement.

According to an exemplary embodiment a method for calculating flow parameters comprises: comparing of a predicted image of a flow with an image of a flow with respect to a reliability map of an image of the flow; and adaptation of the predicted image of a flow with respect to the result of the comparing.

According to an exemplary embodiment the reliability map (18) depends on a geometry (21) of an object.

According to an exemplary embodiment the geometry is derived on basis of images of the object.

According to another exemplary embodiment the reliability map depends on a device, which generates the image.

According to a further exemplary embodiment the reliability map is displayed for evaluation of the method for measurement.

According to an exemplary embodiment a use of the above-mentioned methods for a diagnostic angiogram, especially for a coronary angiogram is provided.

According to an exemplary embodiment a device for measurement of a flow in an object, especially a lumen or a vessel, comprises: an imager for generating a temporal sequence of images of the object; a determiner for determining reliability maps, whereas a reliability map corresponds to an image of the object; a second determiner adapted to determine the flow based on the temporal sequence of images of the object and the reliability maps.

According to another exemplary embodiment the reliability map depends on a geometry of the object.

According to another exemplary embodiment the geometry is based on the images of the object.

According to an exemplary embodiment the reliability map depends on a device, which generates the sequence of images.

According to an exemplary embodiment the device further comprises: an injector for injecting a contrast agent into the object, especially the vessel; a determiner for determining the flow at least partially based on a temporal sequence of images of the contrast agent.

According to a further exemplary embodiment the images are differently oriented.

According to an exemplary embodiment the reliability map depends on the relationship between the direction of the flow and the direction of the image.

According to a further exemplary embodiment the reliability map depends on overlapping lumens, especially on overlapping vessels.

According to an exemplary embodiment the reliability map depends on the quality of the image, especially on edges in a mask image or on artefacts.

According to an exemplary embodiment the device further comprises a visual indicator for displaying the reliability map for evaluation of the method for measurement.

According to a further exemplary embodiment a device, comprises: a comparator for comparing of a predicted image of a flow with an image of a flow with respect to a reliability map of an image of the flow; and an adaptor for adaptation of the predicted image of a flow with respect to the result of the comparing.

According to an exemplary embodiment the reliability map depends on a geometry of an object.

According to an exemplary embodiment the geometry is based on images of the object.

According to an exemplary embodiment the reliability map depends on a device, which generates the image.

According to another exemplary embodiment the device further comprises a visual indicator for displaying the reliability map for evaluation of the method for measurement.

An exemplary aspect of an exemplary embodiment of the invention may be seen in that a computer program having instructions recorded thereon in order to execute one of the methods according to claims 1 to 13.

According to another exemplary embodiment a computer readable medium having stored thereon a computer program according to claim 32 is provided.

It is provided possibilities to evaluate a temporal sequence of images according to different criteria. E.g. the area of overlapping vessels, the movement of the object, e.g. because of heartbeat, or the movement of the device to take the images can lead to a lower quality of the image. These aspects will be considered with the help of reliability maps. Therefore, a reliability map provide information about the reliability of single aspects of an image. The result thereof is to avoid misinterpretation of an image.

It should be noted that the above features may also be combined. The combination of the above features may also lead to synergetic effects, even if not explicitly described in detail.

These and other aspects of the present invention will become apparent from and elucidated with reference to the embodiments described hereinafter.

### BRIEF DESCRIPTION OF THE DRAWINGS

Exemplary embodiments of the present invention are described in the following with reference to the following drawings in which:

FIG. 1 shows two DIC-diagrams;

FIG. 2 shows a flow map;

FIG. 3 shows two TIC-diagrams;

FIG. 4 shows 4 landmarks along a vessel of interest in a coronary angiogram;

FIG. 5 shows a frame with partially overlapping coronaries and reliability values along the centerline of the vessel of interest;

FIG. 6 shows another frame with partially overlapping coronaries and reliability values along the centerline of the vessel of interest;

FIG. 7 shows another frame with partially overlapping coronaries and reliability values along the centerline of the vessel of interest;

FIG. 8 shows a flow map of a carotid bifurcation;

FIG. 9 shows a reliability map of a carotid bifurcation;

FIG. 10 shows a carotid bifurcation;

FIG. 11 shows a system overview of a fitting process;

FIG. 12 shows a system overview of a fitting process without reconstruction, segmentation unit;

FIG. 13 shows an extracted flow map obtained from an experimental setup;

FIG. 14 shows a simulated flow map;

FIG. 15 shows a computer system;

FIG. 16 shows a flow chart.

### DETAILED DESCRIPTION OF EXEMPLARY EMBODIMENTS

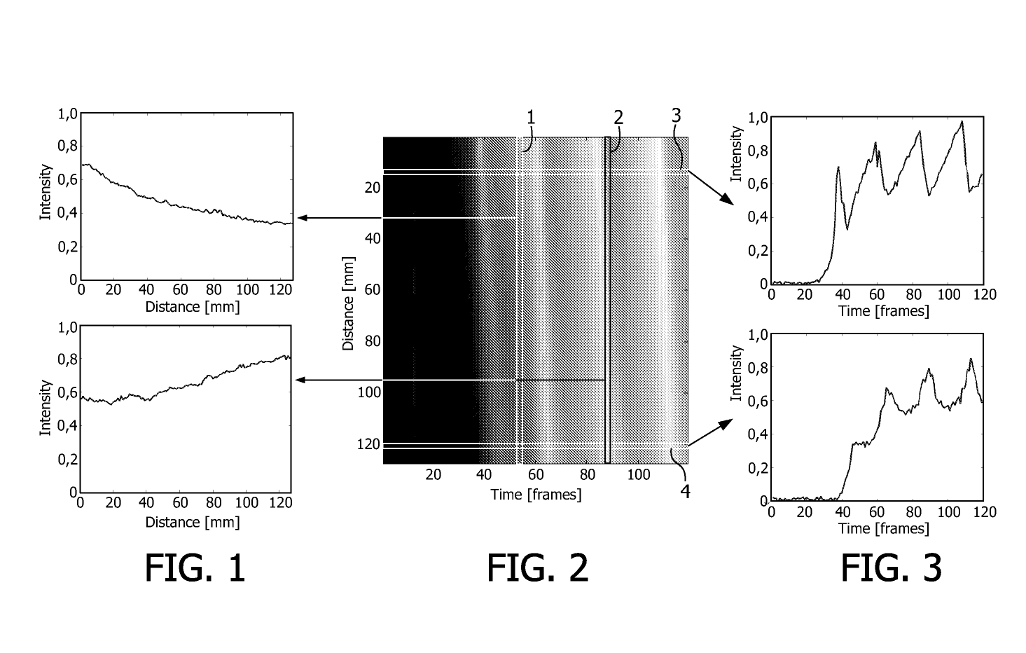

FIGS. 1, 2 and 3 illustrate the relationship between the flow map (FIG. 2) and the time intensity curves TICs (FIG. 3), and the distance intensity curves DICs (FIG. 1). The determined flow from TICs, DICs or a flow map is usually not reliable if the observation of the amount of contrast agent is not reliable.

The flow map is the result of TICs, which are the rows of the flow map, and the DICs, which are the columns of the flow map. According to an exemplary embodiment of the invention the reliability map is used in combination with a flow map.

The reliability map gives the reliability of every entry of the flow map. Instead of working with complete DICs or TICs the flow extraction system then works on the valid patches of the flow map. FIG. 1 illustrates two diagrams of DICs. FIG. 2 shows two columns 1 and further two columns 2, which correspond to the two diagrams of DICs of the FIG. 1. There are also two rows 3 and further two rows 4, which correspond to the two diagrams of TICs of the FIG. 3.

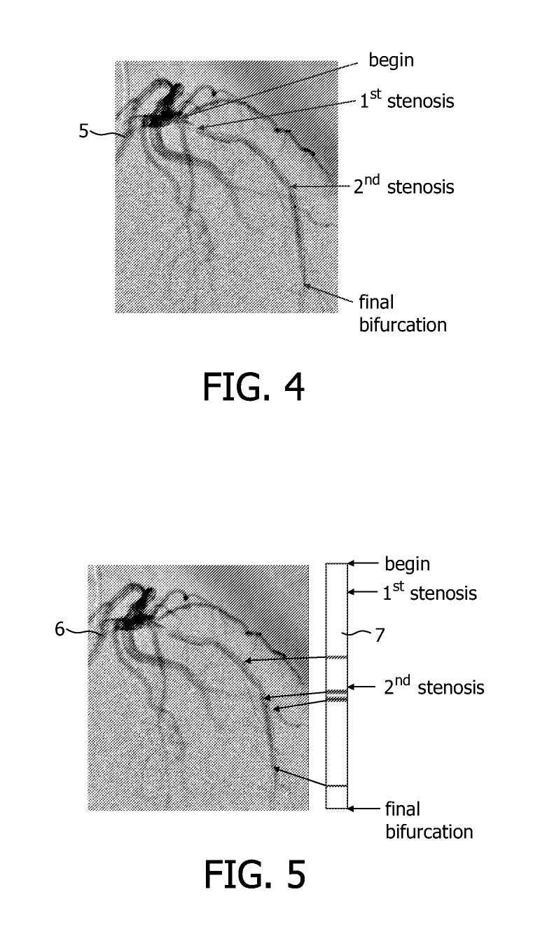

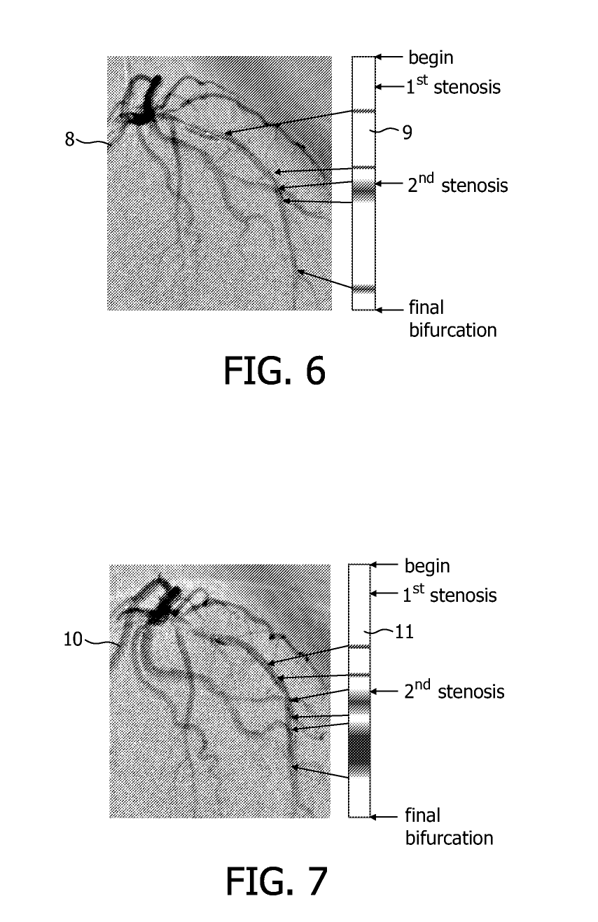

The FIGS. 4 to 7 give an example for coronary angiography. It is illustrated overlapping vessels due to cardiac motion. The FIG. 4 shows a frame of overlapping vessels 5, whereas landmarks along the vessel of interest are depicted. The FIGS. 5, 6 and 7 show different frames 6, 8, 10 with different overlapping. For every frame 6, 8, 10 in FIGS. 5, 6 and 7 the reliability values 7, 9, 11 along the centreline of the vessel of interest are given, whereas light-coloured areas indicate areas with high reliability and dark areas indicate areas with minor reliability.

In every frame 5, 6, 8, 10 some parts of the vessel of interest are occluded by another vessel, but in every frame 5, 6, 8, 10 different parts are occluded. For every frame 5, 6, 8, 10 the reliability values are given along the vessel centerline. The reliabilities for all frames 5, 6, 8, 10 and for all points along the centerline compose the reliability map.

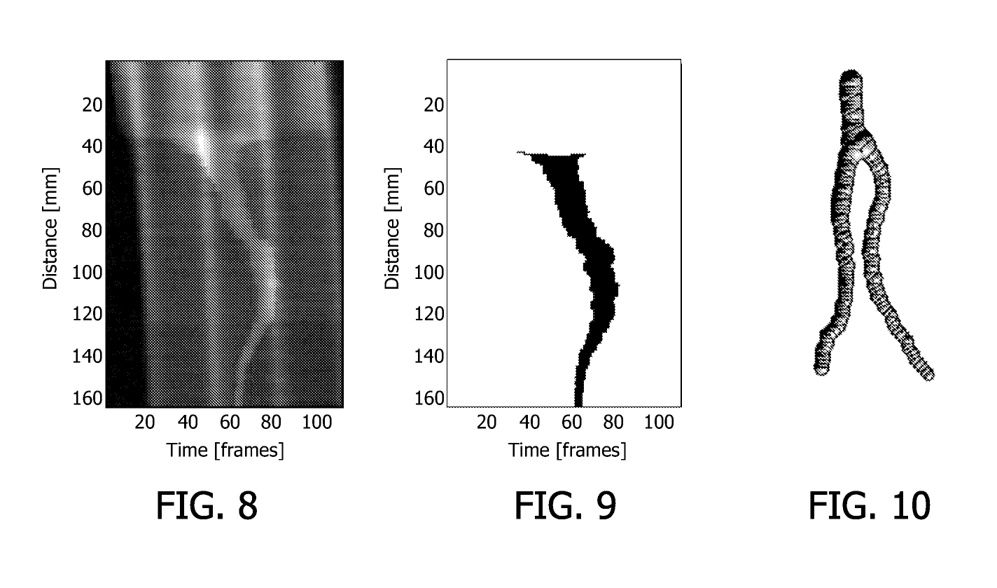

FIG. 8 shows a flow map with invalid patches due to an overlapping vessel. FIG. 9 illustrates a reliability map of a carotid bifurcation imaged with a rotating x-ray device and FIG. 10 depicts the according geometry, namely a carotid bifurcation.

As an exemplary embodiment, the geometry of the vessels can be obtained from the images of the flow themselves. In order to extract the flow in the carotid arteries from rotational angiography at first the 3D geometry of the visible vessel tree and the 3D centreline of the vessel of interest is determined, either from the sequence of projection images or from the 3DRA volume reconstruction.

The flow map is determined by projection of the points of the centreline to the detector planes. The reliability map 18 can be determined from the geometry 21 of the whole vessel tree. The reliability is zero if there is an overlapping vessel. In the case of foreshortening the reliability depends on the angle between the vessel and the x-ray beam. Additionally the reliability can be reduced if artifacts can be created by the comparison to mask images. If none of the above applies the reliability is one.

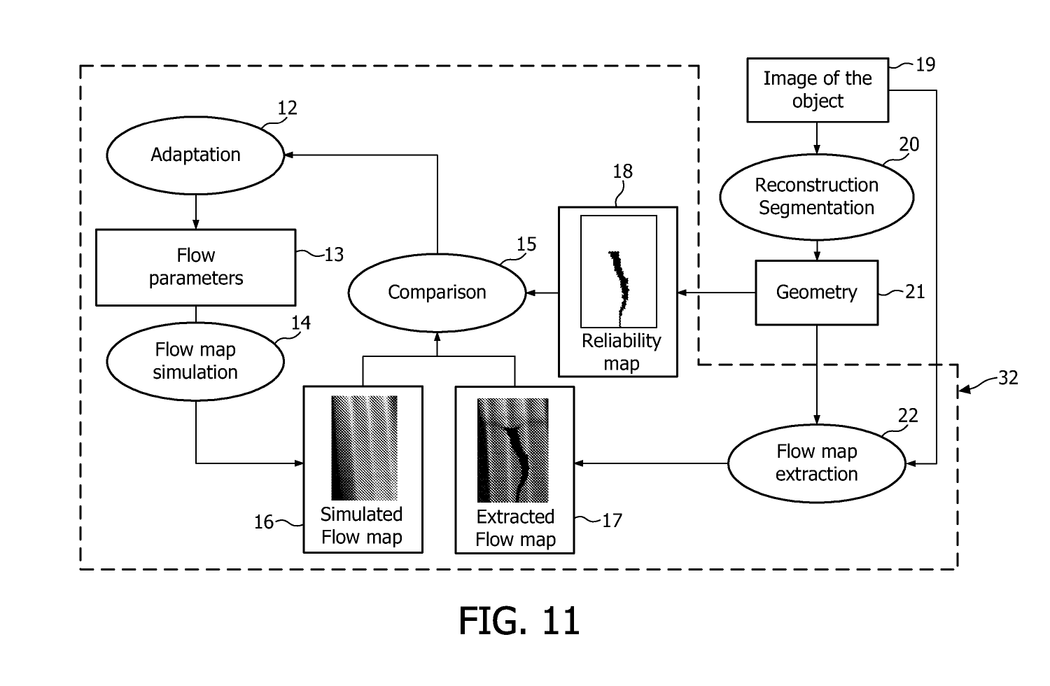

The FIG. 11 depicts the role of the reliability map 18, whereas a system overview of the fitting process is illustrated, whereas the fitting process can be e.g. a model based flow map fitting process. The reliability map 18 is used for weighting during the comparison 15. According to the invention it is introduced a reliability map 18, which gives the reliability of every entry of the flow map. The reliability map 18 can, for instance, be estimated from the geometric overlap of the vascular structures in an image sequence. The extraction of quantitative flow characteristics can be done by simulating a flow map, comparing 15 the simulated flow map with the observed flow map and optimizing the difference between both. The usage of the reliability map 18 within the comparison 15 enables the extraction of (quantitative) flow characteristics from coronary angiography and from rotational angiography.

As one further example, the geometry of the lumen or vessel can be extracted from the images showing flow. Here, an image of the object 19 is also input to a reconstruction and segmentation 20. This leads to a geometry 21 which is input to a determiner 32. The result thereof is a reliability map 18. The image of the object leads also to a flow map extraction 21. The flow map extraction 22 results in an extracted flow map 17, which corresponds an image of a flow. There is also a comparison 15 of the simulated flow map 16, which corresponds a predicted image of a flow, and the extracted flow map 17, which leads to an adaptation 12 of flow parameters 13. Because of these adapted flow parameters 13 a flow map simulation 14 can be calculated. This simulated flow map 16 can again be compared with an extracted flow map 17.

Therefore, the flow map and the reliability map 18 are input to a model based flow extraction system. An example for this is the determination of flow from a x-ray sequence.

The parameters of the x-ray system and the parameters of the injection are assumed to be known. Starting with initial guesses for the flow parameters, a flow map is simulated 16. Average volume flow, flow waveform and flow profile are then adapted to determine the best fit of the extracted flow map 17 and the simulated flow map 16. During the fitting the reliability map 18 gives the weighting parameters for the error function.

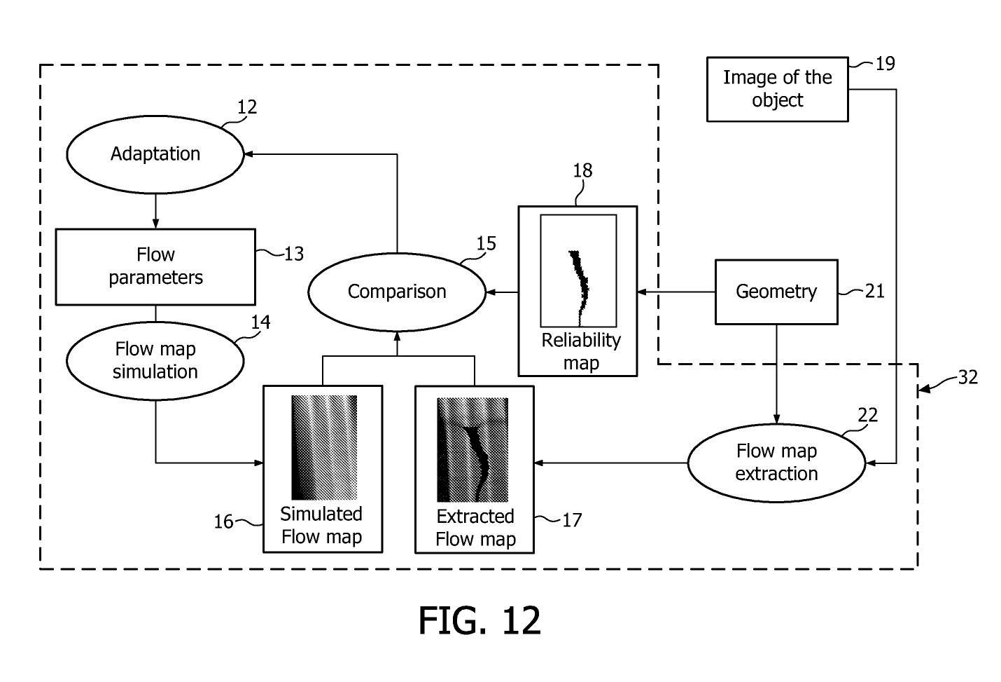

The FIG. 12 shows a similar flow diagram as depicted in FIG. 11. The only difference between both FIGS. 11 and 12 is that there is no step of reconstruction and segmentation. The geometry 21 can be derived e.g. from a former analysis or calculation without the need of an image of the object 19. In this case the reconstruction and segmentation can be omitted.

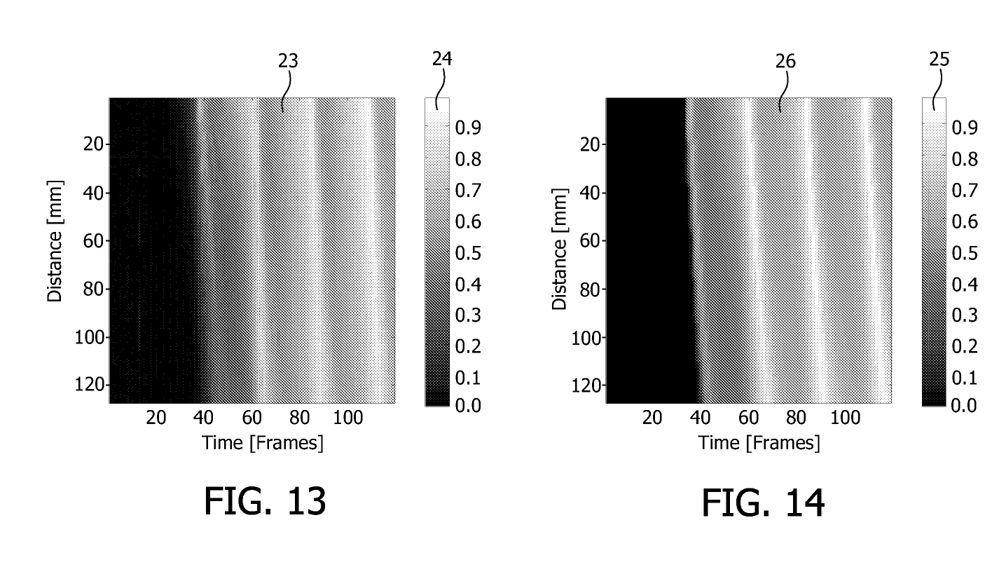

The FIGS. 13 and 14 show examples for an extracted flow map obtained from an experimental setup (FIG. 13) and a simulated flow map (FIG. 14). The parameters of the simulation are adapted to fit the simulated flow map to the extracted flow map.

These exemplary methods according to the invention can be used to extract blood flow from standard coronary angiograms and from rotational acquisitions, e.g. for neurovascular applications.

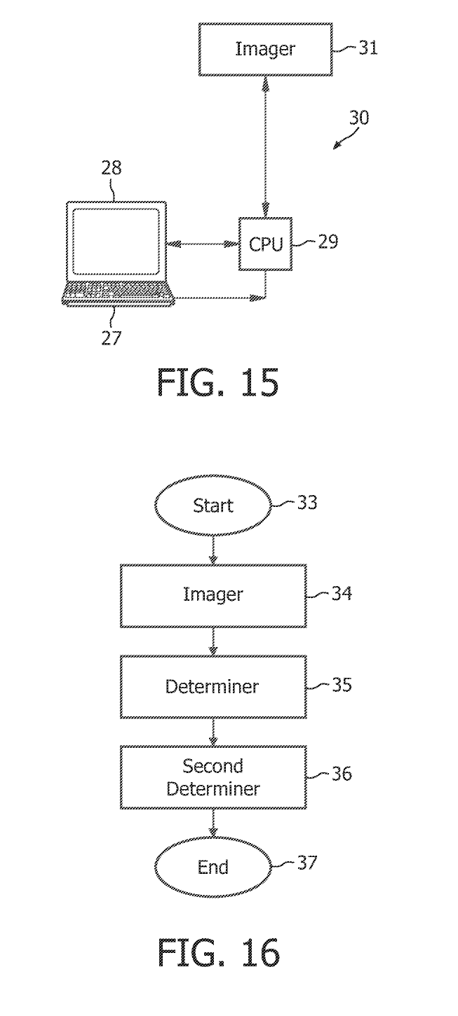

The FIG. 15 shows a computer system 30 with a keyboard 27, a display 28 and a CPU 29 as well as an imager 31. The imager 31 generates a temporal sequence of images of the object; the computer system 30 determines the reliability maps, whereas a reliability map corresponds to an image of the object.

The FIG. 16 shows a flow chart, which corresponds to the claim 1 or 17, respectively. The flow chart shows a special succession, whereas this is not the only succession, which has to be understood according to the claims. In fact the claims comprise also further different successions of the different units.

It is disclosed a method and a device for measurement of a flow in an object, especially a lumen or a vessel, comprising: generating a temporal sequence of images of the object; determining reliability maps, whereas a reliability map corresponds to an image of the object. Another exemplary embodiment is a method and a device for calculating flow parameters (13), comprising: comparing (15) of a predicted image of a flow (16) with an image of a flow (17) with respect to a reliability map (18) of an image of the flow; and adaptation (12) of the predicted image of a flow (16) with respect to the result of the comparing (15). Furthermore, it is described a computer program having instructions recorded thereon in order to execute one of the above-mentioned methods.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosures, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the internet or other wired or wireless telecommunication systems. Any reference signs in the claims should not be construed as limiting the scope.

### LIST OF REFERENCE SIGNS

1 two columns in a flow map;
2 two columns in a flow map;
3 two rows in a flow map;
4 two rows in a flow map;
5 frame of overlapping vessels;
6 frame of overlapping vessels;
7 reliability values;
8 frame of overlapping vessels;
9 reliability values;
10 frame of overlapping vessels;
11 reliability values;
12 adaptation unit;
13 flow parameters unit;
14 flow map simulation;
15 comparison unit;
16 simulated flow map unit;
17 extracted flow map unit;
18 reliability map unit;
19 image of the object unit;
20 reconstruction, segmentation unit;
21 geometry unit;
22 flow map extraction unit;
23 flow map;
24 reliability values;
25 reliability values;
26 flow map;
27 keyboard;
28 display;
29 CPU;
30 Computer system;
31 imager;
32 determiner;
33 start of a flow chart;
34 imager;
35 determiner;
36 second determiner;
37 end of a flow chart.

1. A method for measurement of a flow in an object. comprising:
generating a temporal sequence of images of the object (34);
determining reliability maps, wherein a reliability map corresponds to an image of the object (35);
determining the flow based on the temporal sequence of images of the object and the reliability maps (36).

2. The method according to claim 1, wherein the reliability map depends on a geometry of the object.

3. The method according to claim 2, wherein the geometry is derived on basis of the images of the object.

4. The method according to claim 1, wherein the reliability map depends on a device, which generates the sequence of images.

5. The method according to claim 1, further comprising:
injecting a contrast agent into the object;
determining the flow at least partially based on a temporal sequence of images of the contrast agent.

6. (canceled)

7. The method according to claim 1, wherein the reliability map depends on the relationship between the direction of the flow and the direction of the image.

8. The method according to claim 1, wherein the reliability map depends on overlapping lumens.

9. (canceled)

10. The method according to claim 1, wherein the reliability map is displayed for evaluation of the method for measurement.

11. (canceled)

12. (canceled)

13. (canceled)

14. (canceled)

15. (canceled)

16. A use of claim 1 for a diagnostic angiogram.

17. A device for measurement of a flow in an object, especially a lumen or a vessel, comprising:
an imager for generating a temporal sequence of images of the object (34);
a determiner for determining reliability maps, wherein a reliability map corresponds to an image of the object (35);
a second determiner adapted to determine the flow based on the temporal sequence of images of the object and the reliability maps (36).

18. The device according to claim 17, wherein the reliability map depends on a geometry of the object.

19. The device according to claim 18, wherein the geometry is based on the images of the object.

20. The device according to claim 17, wherein the reliability map depends on a device, which generates the sequence of images.

21. The device according to claim 17, further comprising:
an injector for injecting a contrast agent into the object, especially the vessel;
an determiner for determining the flow at least partially based on a temporal sequence of images of the contrast agent.

22. (canceled)

23. The device according to claim 17, wherein the reliability map depends on the relationship between the direction of the flow and the direction of the image.

24. The device according to claim 17, wherein the reliability map depends on overlapping lumens.

25. (canceled)

26. The device according to claim 17, further comprising a visual indicator for displaying the reliability map for evaluation of the method for measurement.

27. A device for calculating flow parameters (13), comprising:
a comparator for comparing (15) of a predicted image of a flow (16) with an image of a flow (17) with respect to a reliability map (18) of an image of the flow; and an adaptor for adaptation (12) of the predicted flow (16) with respect to the result of the comparing (15).

28. The device according to claim 27, wherein the reliability map (18) depends on a geometry (21) of an object.

29. (canceled)

30. (canceled)

31. (canceled)

32. (canceled)

33. Computer readable medium having stored thereon a computer program having instructions in order to execute the method according to claim 1.
